(19) United States
(12) Patent Application Publication
(10) Pub. No.: US 2007/0194128 A1
(43) Pub. Date: Aug. 23, 2007

(54) Promotional items having a card receiving area for holding and displaying a card

(76) Inventors: Matthew T. Coe, Annandale, NJ (US); Richard Costa, Bedminster, NJ (US); Hung Mach, Fort Lee, NJ (US); Fred Pether, St. Petersburg, FL (US)

Correspondence Address: Allen R. Kipnes, Esq.;WATOV & KIPNES, P.C., P.O. Box 247, Princeton Junction, NJ, 08550, US

(21) Appl. No.: 11/360,709

(22) Filed: Feb. 23, 2006

(51) Int. Cl. G06K 7/00

(52) U.S. Cl. 235/486

(57) ABSTRACT

A promotional item includes a promotional item portion; and a housing portion having a card receiving area for retaining a card, in operative association with the promotional item portion, and the housing portion further having at least one surface being at least partially see-through for displaying the retained card therethrough.

### FIELD OF THE INVENTION

The present invention is relates to promotional items, and more particularly a promotional item integrally equipped with a card receiving area for holding and displaying one or more cards.

### BACKGROUND OF THE INVENTION

Nearly $17.5 billion a year is spent by companies in the U.S., each year on the manufacture and distribution of promotional or novelty items. Promotional items generally utilize a technique to attract and maintain the user's interest, and include some form of advertising message or business logo. Typically, the advertising message is printed or applied directly on the promotional item to ensure good visibility to the user. Sponsoring parties generally use promotional items to get a message to a target audience for a lasting period of time, in order to enhance business revenues, market recognition or public image. Promotional items are often regarded as tangible, handheld commercials that affect to some degree a part of the users' everyday lives, thus providing an effective form of information conveying vehicle. Examples of typical promotional items include key chains, pens and pencils, magnets, rulers, hats/apparels, bottle openers, portable flash drives/computer related products, calculators and thus, generally extends to any item having at least one utility element.

Promotional items may also be in the form of pill cases, also known as pill boxes, which are compact containers for housing medications such as pills, tablets, or capsules. Personal pill cases are known in the art, and are typically designed to be small and unobtrusive so that they can be carried in a purse or in a shirt pocket or other convenient location. They allow users to pack and conveniently carry limited individualized dosages of one or more medications.

Personal pill cases typically include multiple compartments, which are generally individually accessible by the user through a common closure or corresponding multiple closures. Each compartment is adapted to receive and retain a single grouping or dose of one or more medications to be taken at a particular time, which may be individually identified by indicia printed on the closure or in proximity to the compartments. In this manner, the personal pill cases can be implemented to enable users to take their medication at the appointed times.

The number or amount of dosages held in such personal pill cases is limited, so the user must periodically refill the case from the standard pill containers supplied by the pharmacist. Such small, pocket-sized pill cases, which have been used for years, allow the user to pre-fill the container with medication to be dispensed for that day, and to conveniently carry it with them. These personal pill cases have been found to enhance the ease and regularity of administration by reminding the user of the proper time for dispensing of pills in a consistent manner. In addition, their small size and compact profile make them especially convenient for individuals needing to take medications at scheduled intervals.

Physicians typically include instructions with prescriptions pertaining to the frequency of ingestion of prescribed medication in specific time intervals (e.g. once a day or after every meal). Such intervals may range from a matter of hours to a day or more, depending on the medication and the condition being treated. Prescription medications are typically filled for the patient with the necessary drug information supplied by the pharmacist. Many over-the-counter medications include packaging printed with necessary drug information such as administration instructions and dosing, symptoms and conditions to be treated, warnings, ingredients, and the like to inform patients of proper dispensing. The drug information accompanying such medications is important to ensure compliance on the part of the patient and that the patient is properly informed about the particulars of the corresponding drug regimen.

Such drug information, however, may not be readily accessible for patients who choose to use personal pill cases to store and carry their pills. While traditional personal pill cases facilitate the use and transportation of medications, such cases have been found to be inadequate when the user needs to access or carry information regarding the medication contained therein. In such an instance, the user often may not be able to retrieve the information in a timely manner, and could inadvertently take the medications in an improper manner.

There is a need for promotional items that comprise a card receiving area for retaining and displaying information or message to the user in a meaningful, creative and long-lasting manner. Such promotional items are generally distributed with the intention of promoting a business or increase market interest in, or sales of, a product, brand, service or the like. There is a further need for providing such promotional items in the form of pill cases that comprise a card receiving area for permitting ready access to information that may be useful to the patient and medical provider including appointment reminders, medication instructions, details such as dosage regimen, patient medical history, a physician's business card, which provides access to the physician's address and telephone number, a medical or insurance identification card, and the like. Such pill cases are suitably adapted to accommodate one or more dosable ingestible products typically in the form of pill medications which may be administered at the same or different time intervals and/or groupings during the day, while maintaining ease of use and storage and carry convenience.

### SUMMARY OF THE INVENTION

The present invention relates generally to promotional item comprising a housing portion defining a card receiving area for retaining a card, in operative association with a promotional item portion. The promotional item portion includes a utility element that encourages or induces the user to possess, use, display and share with others the promotional item. As used herein, “utility element” is intended to refer to a portion of the promotional item that provides a useful capacity and a practical use, in addition, to the promotional and advertising aspects. The housing portion includes at least see-through one surface that is, for example, at least partially transparent or translucent to enable the user to view the information contained on the card for quick and easy reference as needed. More preferably, the housing portion includes a first surface and an opposing second surface wherein at least one of the first and second surfaces is at least partially see-through to enable the user to view the information contained on the corresponding sides of the card for quick and easy reference as needed, and is adapted to be movable between a first position and a second position.

The promotional item may be in a form selected from, for example, pill cases, key chains, pens and pencils, magnets, rulers, hats/apparels, radios, beverage coasters, bottle openers, portable flash drives/computer related products, calculators, timers, shoehorns, and the like.

In a preferred form of the present invention, the promotional item is in the form of a pill case.

The pill case of the present invention comprises a pill holding portion including at least one compartment or slot designed to hold several groupings or doses of one or more pills as broadly defined herein which may or may not contain an active ingredient such as a medication, and the like. Each compartment defines a single area for holding a single pill or a group of pills. The compartment may further be provided with indicia to assist the user in identifying the pills contained therein and which dosages are to be administered at a particular scheduled time.

The pill holding portion of the pill case may be adapted to receive and accommodate any number of pills depending on the maximum capacity of the case for matching with a particular dosage regimen particularly suited for the patient. For example, if the patient requires a 7-day medication regimen or a 14-day regimen, then the pill holding portion of the pill case may be filled to accommodate the required number of pills. The pill case of the present invention can therefore accommodate short- and long-term prescriptions and is thus not limited to dosage regimens that are multiples of seven.

The pill case of the present invention further comprises a housing portion defining a card receiving area, in operative association with the pill holding portion thereof. The housing portion includes at least one surface that is at least partially see-through to enable the user to view the information contained on the card for quick and easy reference as needed. More preferably, the housing portion includes a first surface and an opposing second surface wherein at least one of the first and second surfaces is at least partially see-through to enable the user to view the information contained on the corresponding sides of the card for quick and easy reference as needed, and is further adapted to move between a first position and a second position.

Suitable cards include those selected from business cards, appointment cards, drug information cards, electronic smart cards, a physician's business card, which provides access to the physician's address and telephone number, a medication or insurance identification card, and the like.

The pill case of the present invention permits the user to visually determine whether a particular grouping or dose had been taken. The present invention further provides the user with a simple tool to organize, store, and remember the proper schedule for administering medication, all within a personal pill container that is compact so that it may be readily carried in a pocket, purse or the like.

It will be understood that reference to the term “pill” as used herein shall include not only pills of a variety of shapes and sizes but all forms of dispensable solid products or articles of manufacture such as chewing gums, confectionery products (e.g., hard candies) which may include an active agent such as a medication, vitamin, nutraceutical and the like which can effectively be housed in the device of the present invention. Examples of “pills” as used herein include any solid ingestible product that can be carried in a pill case, including tablets, capsules, lozenges, caplets and the like. Likewise, all reference to a “pill case” shall mean a container, which can accommodate the dispensable product or article of manufacture.

It will be understood that the present invention is not limited to pill cases which is provided as an illustrative example, and may extend to any promotional item comprising a promotional item portion and a card receiving area in operative association with the promotional item portion, and which is intended to be distributed to the public in order to generate increased awareness about a product, brand, service or the like.

In one aspect of the present invention, there is provided a promotional item, comprising:

a promotional item portion; and

a housing portion comprising a card receiving area for retaining a card, in operative association with the promotional item portion, the housing portion further comprising at least one surface being at least partially see-through for displaying the retained card therethrough.

In another aspect of the present invention, there is provided a pill case comprising:

a pill holding portion comprising at least one pill holding compartment for receiving and retaining at least one pill therein; and

a housing portion comprising a card receiving area for retaining a card, in operative association with the pill holding portion, the housing portion further comprising at least one surface being at least partially see-through for displaying the retained card therethrough.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a top perspective view of promotional item in the form of a pill case for one embodiment of the present invention;

FIG. 2 is a top perspective view of the pill case of FIG. 1 with a pill holding portion and a card receiving portion in the open positions in accordance with the present invention;

FIG. 3 is a bottom perspective view of the pill case shown in FIG. 2 in accordance with the present invention;

FIG. 4 is a front perspective view of the pill case in a partially opened position in accordance with the present invention;

FIG. 5 is a rear perspective view of the pill case of FIG. 4 in accordance with the present invention; FIG. 6 is an assembly view of a promotional item in the form of a pill case for another embodiment of the present invention;

FIG. 7 is a front assembly view of the pill case of FIG. 6 in an open position in accordance with the present invention;

FIG. 8 is a rear assembly view of the pill case of FIG. 7 in accordance with the present invention;

FIG. 9 is a perspective view of a promotional item in the form of a pill case in an open position for another embodiment of the present invention;

FIG. 10 is a rear elevation view of the pill case of FIG. 9 in accordance with the present invention;

FIG. 11 is a perspective view of a promotional item in the form of a pill case for another embodiment of the present invention; and

FIG. 12 is an exploded assembly view of the pill case of FIG. 11 in accordance with the present invention.

### DETAILED DESCRIPTION OF THE INVENTION

The present invention is directed to a promotional item comprising a housing portion defining a card receiving area for retaining a card, in operative association with a promotional item portion. The promotional item portion includes a utility element that encourages or induces the user to possess, use, display and share with others the promotional item. As used herein, “utility element” is intended to refer to a portion of the promotional item that provides a useful capacity and a practical use, in addition, to the promotional and advertising aspects. The housing portion includes at least one surface that is at least partially see through to enable the user to view the information contained on the card quick and easy reference as needed. More preferably, the housing portion includes a first surface and an opposing second surface wherein at least one of the first and second surfaces is at least partially see-through to enable the user to view the information contained on the corresponding sides of the card for quick and easy reference as needed, and is adapted to be movable between a first position and a second position.

The promotional item may be selected from, for example, pill cases, key chains, pens and pencils, magnets, rulers, hats/apparels, radios, beverage coasters, bottle openers, portable flash drives/computer related products, calculators, timers, shoehorns and the like.

As discussed, the card receiving area is adapted for holding and displaying at least one card. Suitable cards may be selected from business cards, appointment cards, drug information cards, electronic smart cards, driver's license cards, identification cards, credit/debit cards, prescription cards, smart cards containing chip card technology (i.e., integrated circuit card) such as an electronic medical ID card which may hold information about the patient or owner of the pill case in electronic form, physician's business cards, which provides access to the physician's address and telephone number, medication or insurance identification cards, and the like.

The term “promotional item” refers to any tangible and useful item or merchandise distributed to the public in an effort to promote a business or increase interest in, or sales of, a product. Such promotional items generally comprise a utility element that induces a target user to keep the item for an extended period of time. The selection of the promotional item will depend on several factors, including, but not limited to, the market needs, the target audience, the product marketed, the intended message conveyed, the desired image, and the level of visibility required. The selection of a suitable promotional item can be readily implemented by one of ordinary skill in the art.

While the principles of the present invention may be implemented into practice in making a number of articles, a description thereof will be made with respect to several embodiments, which are used for advertising, display, promotional, instructional, or educational purposes.

In a particular embodiment of the present invention, there is provided a promotional item in the form of a pill case useful for facilitating proper medication dosing over a regimen period. The pill case of the present invention enhances the ease and regularity of administration by reminding the user of the proper time for dispensing of pills in a consistent manner. In addition, their small size and compact profile make them especially convenient for individuals taking medications at scheduled intervals. The pill case of the present invention is designed to assist and facilitate medication compliance for the patient. The pill case of the present invention is capable of accommodating any number of doses, and reduces the time and expense associated with packaging and dispensing pills. The pill case of the present invention is simple to fabricate, low in cost, and easy to implement, thus making them especially suitable for use by patients and medical providers.

In one embodiment of the present invention, there is provided a promotional item, comprising a promotional item portion; and a housing portion comprising a card receiving area for retaining a card, in operative association with the promotional item portion, the housing portion further comprising at least one surface being at least partially see-through for displaying the retained card therethrough.

In another embodiment of the present invention, the pill case includes a pill holding portion comprising at least one pill holding compartment for receiving and retaining at least one pill therein; and a housing portion comprising a card receiving area for retaining a card, in operative association with the pill holding portion, the housing portion further comprising at least one surface being at least partially see-through, such as transparent or translucent, for displaying the retained card therethrough.

The card may optionally have at least one surface defining a display area for displaying indicia which can be read or viewed by a user or include an electronic data storage means accessible by a machine-based reading device. Through such means, the card may include indicia or electronic coding suitable for communicating any form of information to a patient or a machine including, but not limited to, appointment reminders, drug facts, administration instructions and dosing, symptoms and conditions to be treated, warnings, ingredients, medical history, and the like, to inform patients of proper dispensing or medical providers treating the patient. Preferably, in each of the embodiments, the card contains printed advertising indicia related to or associated with, for example, a product, brand, company or service.

The card may communicate other forms of information including graphical and electronic communication depending on the application and/or product contained in the pill case of the present invention. The pill case of the present invention is designed to greatly enhance the privacy of the patient by enabling any personal medical or drug information that the patient may prefer to keep undisclosed to be discreetly hidden away or secured from public view, while maintaining accessibility for medical providers (i.e., emergency medical technicians, physicians, and nurses) in emergency situations.

Examples of “pills” as used herein include any solid ingestible product that can be carried in a pill case, including tablets, capsules, lozenges, caplets and the like. Likewise, all reference to a “pill case” shall mean a container which can accommodate the dispensable product or article of manufacture. In this manner, the present invention can be used to store and dispense a variety of solid, edible articles including, but not limited to, gums, confections, vitamins, nutraceuticals, nutritional supplements, and the like, as previously described. For illustrative purposes, reference hereinafter will be to a pill case for dispensing pills, typically containing an active agent. Although rectangular pills slots and housing are shown, it is to be understood that the present pill case may be modified to encompass a range of shapes and sizes as required.

In one setting, the pill case of the present invention can be used by a pharmacist to dispense medication to the patient, and includes a card containing a drug product's logo, drug information associated with the dispensed medication, and instructions as to the administration of the medication in an easy to read format on a substantially flat surface. The patient may subsequently return the pill case to the pharmacist for refilling the same or different medication.

Although the present invention is described hereinafter in context of a pill case as an illustrative example, it is understood that the present invention is not limited to such, and extends to any promotional item comprising a promotional item portion as described herein.

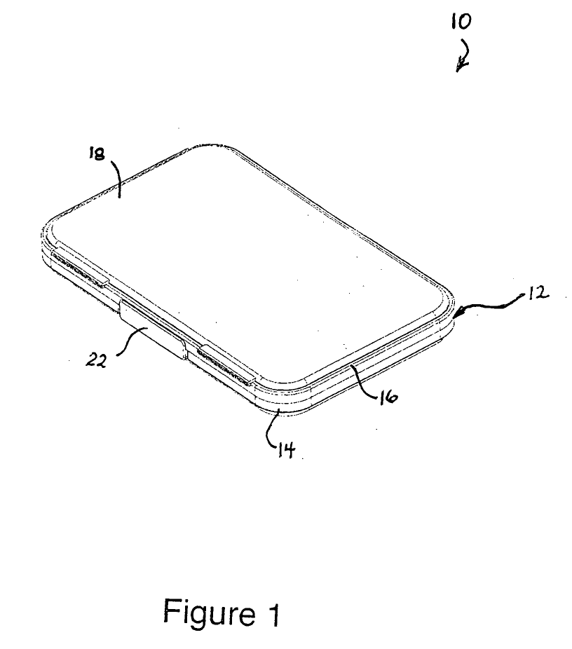

Referring to FIG. 1, there is shown a promotional item in the form of a pill case 10 in accordance with one embodiment of the present invention. Typically, a pharmacist or pharmaceutical supply vendor may load or fill the pill case 10 with medication during dispensing. However, the pill case 10 may be distributed by a physician or a vendor where the patient or end user can load and fill from a standard pill container. For a pre-filled pill case 10, the pill case 10 may be pre-packaged with a drug information/instruction card deposited therein along with the corresponding medication. The pre-filled pill case 10 may thereafter be enclosed within a tamper resistant pouch on which a pharmacist may apply a proper Rx label. The pill case 10 can be fabricated from any rigid, durable, lightweight container-type material including, but not limited to, plastics, and molded or extruded into any size, shape, color and the like for easy identification or association with a particular medication and the like.

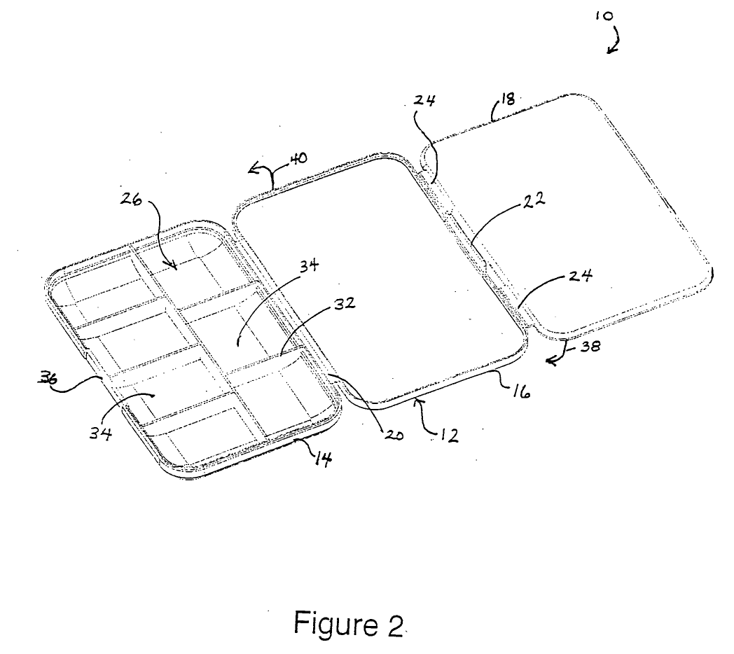

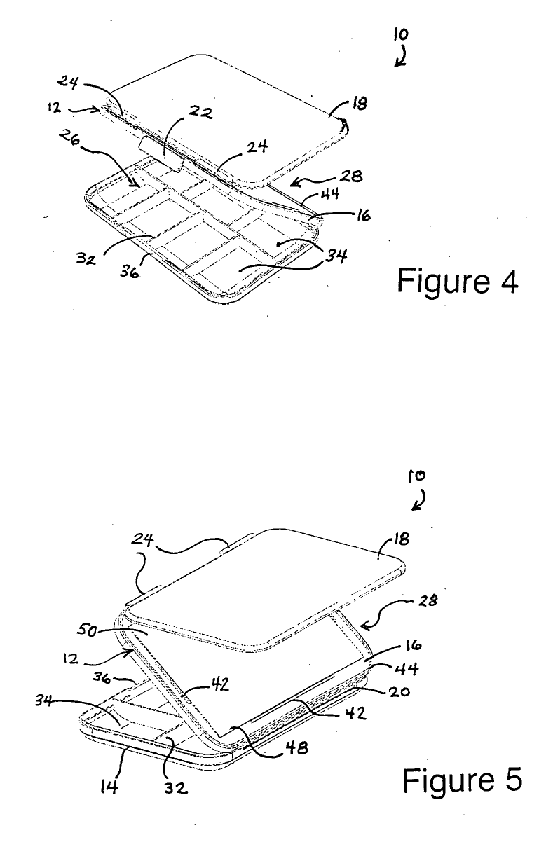

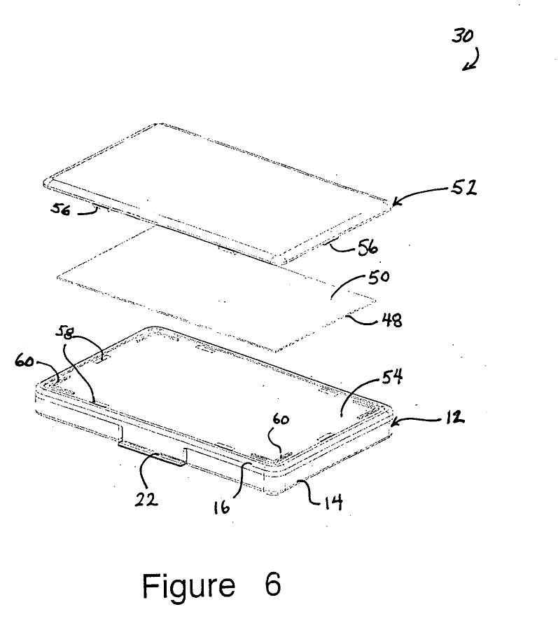

The pill case 10 of the embodiment of FIG. 1, includes a flat rectangular housing 12 including a pill holding base portion 14, a pill lid portion 16, and a card lid portion 18. The pill holding base portion 14 is operatively engaged with the pill lid portion 16 to define an interior pill area 26 (see FIG. 2) for holding pills as will be described hereinafter. The pill lid portion 16 is operatively engaged with the card lid portion 18 to define a corresponding card receiving area or interior card area 28 (see FIGS. 4 and 5) for holding at least one card 48 (see FIG. 5) as will be described hereinafter. The pill lid portion 16 is movably attached to the pill holding base portion 14 through a living hinge 20 (as shown best in FIG. 2), and may be securely retained in the closed position by a latch 22. The card lid portion 18 is movably attached to the pill lid portion 16 through a pair of living hinges 24 (as shown best in FIG. 2), which allows the card lid portion 18 to move pivotally between the closed and open positions.

The card 48 may optionally include at least one surface 50 upon which indicia such as alphanumeric characters, computer readable codes including barcodes, and the like, may be displayed to the patient and/or a scanner. The indicia may communicate to the patient any information including, but not limited to drug information, administration instructions and dosing, symptoms and conditions to be treated, warnings, active ingredients, and the like. Alternatively, the surface 50 may provide a base on which an adhesive label containing specific information such as Rx information can be applied thereon for future reference.

The card 48 may optionally include an integrated circuit using card chip technology for storing electronic information accessible through a computer device. Such cards are also known as “smart cards”. Such smart cards are fabricated with integrated circuitry embedded into a flat, plastic body, and may be in the form of a contact card or a contact-less card. In a contact-type smart card, the circuitry is typically accessible through an area of gold-plated contacts to facilitate contact communication with a suitable card reader. In a non-contact-type smart card, the circuitry communicates with a card reader through wireless means such as those utilizing self-powered induction. The integrated circuit may be programmed to store medically relevant information about the patient or owner of the pill case 10. The use of the pill case 10 to store such smart cards alongside medications, would greatly enhance the ability of medical personnel to quickly locate the cards on the patient in the event of a medical emergency, and access the information to administer life-saving measures.

The card 48 may be composed of any suitable material capable of receiving or supporting information in printed, embossed, etched, electronic or engraved forms, including, but not limited to paper, cardboard, plastic, foil, laminated composites, semiconductor materials for integrated circuits and the like.

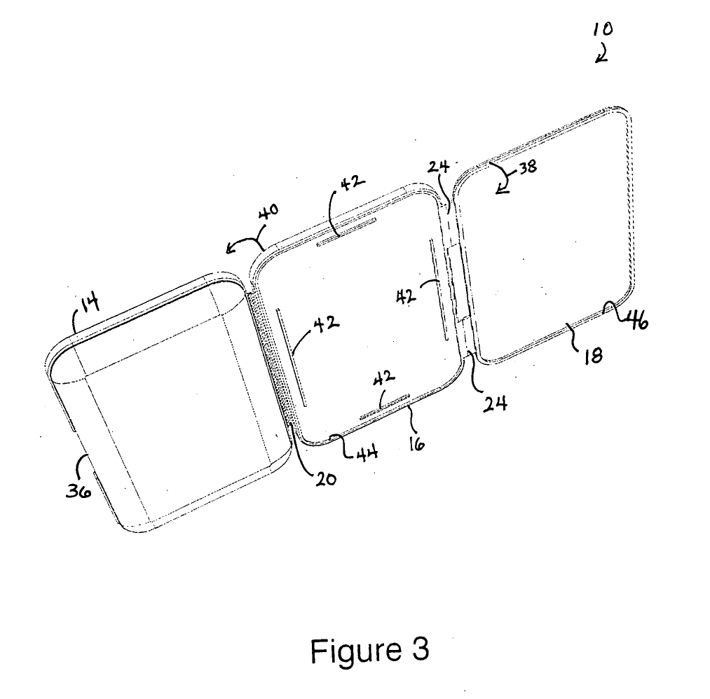

With reference to FIGS. 2 and 3, the pill case 10 is shown with the pill lid portion 16 and card lid portion 18 concurrently in the open positions. The interior pill area 26 includes a plurality of partitions 32 defining multiple pill holding compartments or slots 34. The partitions 32 can be modified according to the quantity of slots 34 needed, preferably numbering from one to seven. In the present embodiment as shown, the pill case 10 is adapted to accommodate up to 7 daily doses. It will be understood, however, that a greater or lesser number of daily doses may be accommodated and stored by the present device in a modified form.

Each slot 34 is suitably dimensioned to discretely accommodate and retain one or more pills for secure storage and subsequent dispensing. The hinge 20 is configured to allow the pill lid portion 16 to be moved pivotally in the direction of arrow 40 toward the closed position. Upon closure of the pill lid portion 16, the latch 22 locks into a ridge 36 located on the pill holding base portion 14, in which, the pill lid portion 16 is held in place, thereby securely retaining the pills contained within the slots 34.

The card lid portion 18 is movably attached to the edge of the pill lid portion 16 opposite from the pill holding base portion 14. The hinges 24 are configured to allow the card lid portion 18 to be moved pivotally in the direction of arrow 38 toward the closed position. In the closed position, the card lid portion 18 located on the opposite side of the pill lid portion 16 from the pill holding base portion 14.

As shown in FIG. 3, the card receiving area 28 includes retaining ridges 42 suitably positioned along the top surface of the pill lid portion 16 to support the card 48 placed thereon, and maintain the card in position, when the card lid portion 18 is moved to an open position. The card receiving area 28 further includes a flange 44 extending along the edge thereof. In the closed position, the flange 44 frictionally engages the outer edge 46 of the card lid portion 18 to keep the card receiving area 28 securely enclosed during handling and storage. The patient simply moves the card lid portion 18 to disengage from the flange 44 and open the interior card area 28 for access to the card 48.

Referring to FIG. 4 and 5, the pill case 10 is shown in partially open positions with respect to the pill lid portion 16 and the card lid portion 18. The pill lid and the card lid portions 16 and 18, respectively, are configured to open at the opposed ends of the pill case 10. This arrangement enables the patient to effortlessly open one area of the pill case 10 without inadvertently opening the other area. In general, the patient can access the pill holding area 26 by disengaging the latch 22 and opening the pill lid portion 16, while keeping the card lid portion 18 preferably in the closed position. The patient can access the card holding area 28 by disengaging the card lid portion 18 from the flange 44 of the pill lid portion 16 as previously noted.

The interior card area 28 is suitably adapted to accommodate one or more cards 48 arranged in a stack. As shown in FIG. 5, the retaining ridges 42 function to hold the card 48 in place, when the card lid portion 18 is open, and prevent the card 48 from falling from the pill case 10 during its opening and closing. The retaining ridges 42 further confines the card 48 within the interior card area 28 to allow the user to properly close the card lid portion 18 with minimal obstruction.

Referring to FIG. 6, a pill case 30 is shown for a second embodiment of the present invention. The pill case 30 includes a housing 12 comprising a pill holding base portion 14, a pill lid portion 16, and a detachable card lid portion 52 adapted for clasped attachment to the pill lid portion 16. The top surface of the pill lid portion 16 supports an interior card area 54 for receiving a card 48 thereon. The detachable card lid portion 52 comprises multiple pegs 56 disposed along the edge portion thereof. The pegs 56 are arranged to fit into corresponding recesses 58 located in the top edge portion of the pill lid portion 16, and snap into the recesses 58 reversibly retaining the card lid portion 52 thereon, and enclosing the card interior card area 54. The top edge portion of the pill lid portion 16 further includes a retaining ridge 60 at each corner thereof to hold the card 48 during removal and replacement of the card lid portion 52.

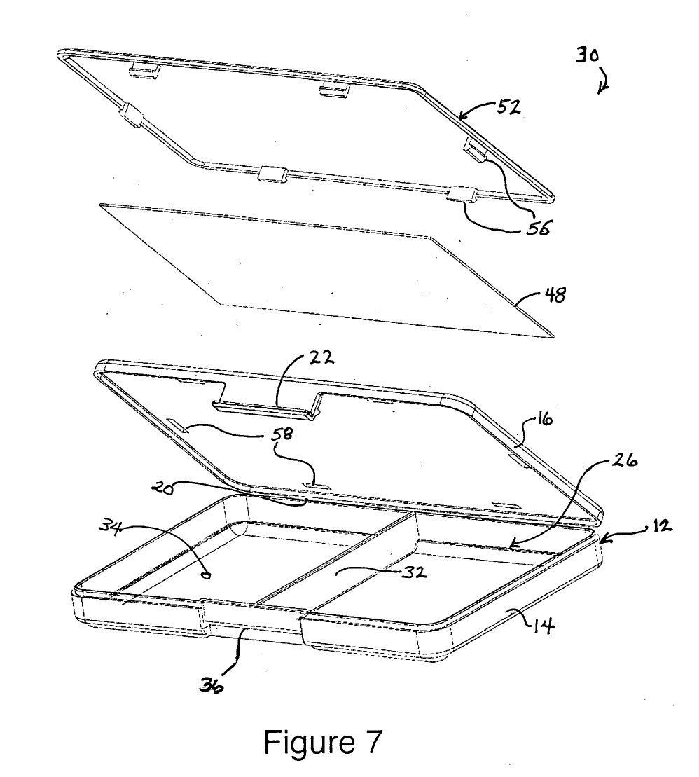

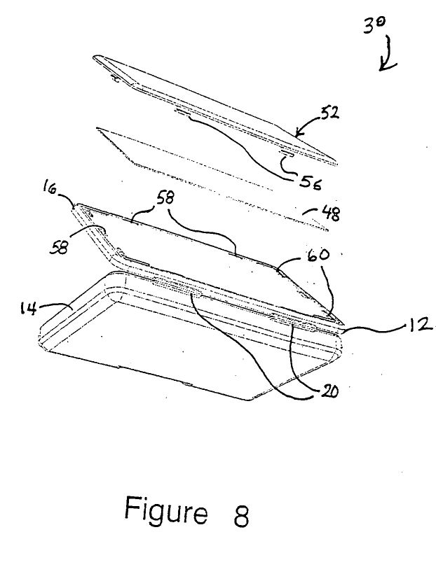

Referring to FIGS. 7 and 8, the pill case 30 is shown with the interior pill area 26 open, and the card lid portion 52 disengaged from the top of the pill lid portion 16. The pill case 30 includes two pill holding slots 34 separated by a partition 32 for receiving one or more pills. The card lid portion 52 may be optionally see-through (e.g., transparent) to allow the card 48 to be visible to the patient from within the card receiving area 26. In this manner, the patient may read the card 48 with the card lid portion 52 secured to the pill case 30. The card lid portion 52 may be removed by disengaging the pegs 52 from the recesses 58 to insert the card 48.

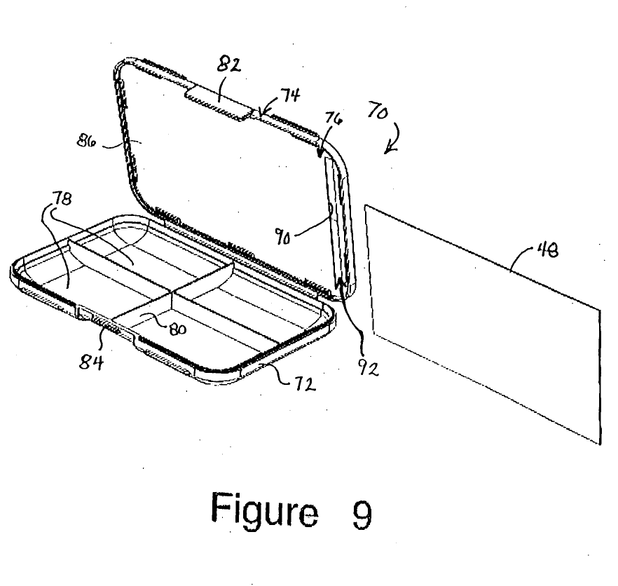

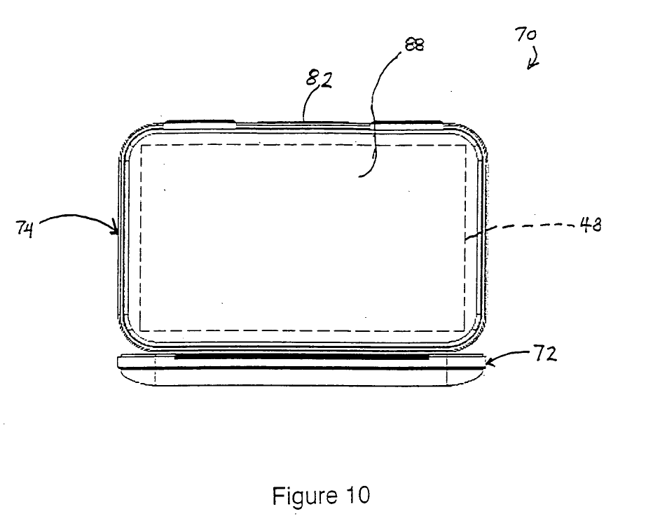

Referring to FIG. 9, a pill case 70 is shown for an alternative embodiment of the present invention. The pill case 70 includes a pill holding portion 72, a lid portion 74 formed in part by a card receiving portion 76. The pill holding portion 72 and the lid portion 74 define multiple pill compartments 78 separated by a partition 80. The lid portion 74 is retained in the closed position by a clasp 82 in operative association with a catch 84 located on the pill holding portion 72. The card receiving portion 76 comprises an interior surface section 86, an exterior surface section 88 (as shown best in FIG. 10), a card receiving area 92 for holding a card 48 defined therebetween, and a slot 90 in communication with the card receiving area 92. The card 48 may be inserted into the card receiving area 92 through slot 90. In the preferred embodiment of the invention, the card receiving area 92 is configured to prevent removal of the card 48 once it is inserted therein.

Referring to FIG. 10, the exterior surface section 88 is preferably at least substantially see-through (e.g., transparent) to allow the user to view the card receiving area 92 and read the information printed on the card 48. In a more preferred embodiment of the present invention, the exterior surface section 88 and the interior surface 86 are at least substantially see-through to allow the user to view the card receiving area 92 from both sides. In this manner, the user can view the information printed on the card 48 with the lid 74 in the closed position on one side, and in an open position on the other side.

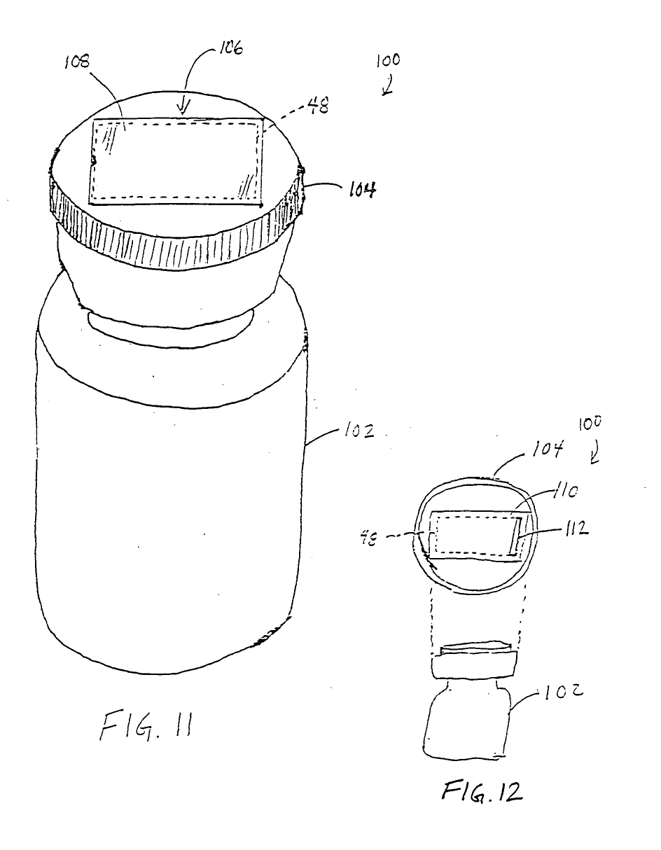

With reference to FIGS. 11 and 12, a pill case 100 in the form of a pill bottle is shown for another embodiment of the present invention. The pill case 100 includes a container body 102 defining an interior portion for holding pills, and a threaded removable lid 104 located at the top end thereof. The lid 104 includes a cover portion 108 and an interior surface 110 thereof, which in combination, define a card receiving area 106 therebetween for holding a card 48.

The interior surface 110 further includes a card slot 112 through which the card 48 is inserted into the card receiving area 106. Preferably, the card slot 112 is configured to prevent removal of the card 48 once inserted. The cover portion 108 is preferably at least substantially see-through to allow viewing of the card 48 with the lid 104 at least threadedly mounted on the container body 102. More preferably, the cover portion 108 and the interior surface 110 of the lid 104 are at least substantially see-through to allow the user to view the card 48 from both sides. In this manner, the user can view the information printed on the card 48 with the lid 104 mounted from one side, and both sides with the lid 104 uncoupled.

Although the promotional item has been depicted in the drawings as a pill case, one skilled in the art will understand that the promotional item may be other items such as key chains, pens and pencils, magnets, rulers, hats/apparels, radios, beverage coasters, bottle openers, portable flash drives/computer related products, calculators, timers, shoehorns and the like.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A promotional item, comprising:
a promotional item portion; and
a housing portion comprising a card receiving area for retaining a card, in operative association with the promotional item portion, the housing portion further comprising at least one surface being at least partially see-through for displaying the retained card therethrough.

2. The promotional item of claim 1 wherein the promotional item is in the form selected from the group consisting of pill cases, key chains, pens and pencils, magnets, rulers, hats/apparels, radios, beverage coasters, bottle openers, portable flash drives/computer related products, calculators, timers, shoehorns and the like.

3. The promotional item of claim 2 wherein the promotional item is in the form of a pill case.

4. The promotional item of claim 1 wherein the housing portion is reversibly removable from the promotional item portion.

5. The promotional item of claim 1 wherein the at least one surface is a first surface and an opposing second surface wherein at least one of the first and second surfaces is at least partially see-through to enable the user to view the information contained on the corresponding sides of the card.

6. The promotional item of claim 5 wherein the housing portion is movable from a first position to a second position to view the corresponding first and second surfaces.

7. The promotional item of claim 1 wherein the card is selected from the group consisting of a business card, an appointment card, a driver's license card, an identification card, a credit/debit card, a prescription card, a medical identification card, a medical insurance card, and combinations thereof.

8. The promotional item of claim 1 wherein the housing portion comprises a slot for passing the card into the card receiving area.

9. The promotional item of claim 8 wherein the slot is configured to prevent removal of the card from the card receiving area.

10. The promotional item of claim 1 wherein the housing portion is hingedly connected to the promotional item portion.

11. The promotional item of claim 1 wherein the at least one surface is at least partially transparent.

12. A pill case, comprising:
a pill holding portion comprising at least one pill holding compartment for receiving and retaining at least one pill therein; and
a housing portion comprising a card receiving area for retaining a card, in operative association with the pill holding portion, the housing portion further comprising at least one surface being at least partially see-through for displaying the retained card therethrough.

13. The pill case of claim 12 wherein the at least one surface of the housing portion is a first surface and an opposing second surface wherein at least one of the first and second surfaces is at least partially see-through to enable the user to view the information contained on the corresponding sides of the card.

14. The promotional item of claim 13 wherein the housing portion is movable from a first position to a second position to view the corresponding first and second surfaces.

15. The pill case of claim 12 wherein the housing portion is reversibly removable from the pill holding portion.

16. The pill case of claim 15 wherein the housing portion is threadedly engaged to the pull holding portion.

17. The pill case of claim 12 wherein:
the pill holding portion is configured to open from a first end to a second end of the pill case; and
the housing portion is configured to open from the second end to the first end of the pill case.

18. The pill case of claim 12 wherein:
the pill holding portion comprises a first lid adapted to open from the first end to the second end of the pill case; and
the housing portion, located on the first lid opposite from the pill holding portion, comprises a second lid adapted to open from the second end to the first end of the pill case.

19. The pill case of claim 18 wherein at least one of the first and second lids is at least partially see-through.

20. The pill case of claim 12 wherein the card is selected from the group consisting of a business card, an appointment card, a driver's license card, an identification card, a credit/debit card, a prescription card, a medical identification card, a medical insurance card, and combinations thereof.

21. The pill case of claim 12 wherein the housing portion further comprises a lid reversibly engaged to the housing portion for providing access to the card receiving area.

22. The pill case of claim 21 wherein the lid is movably attached to the closure of the pill holding portion via a hinge.

23. The pill case of claim 22 wherein the housing portion further comprises a flange extending proximate to the periphery of the card receiving area, said flange adapted to frictionally engage the outer edge of the lid and reversibly secure the lid in the closed position.

24. The pill case of claim 21 wherein the lid is detachably affixed to the housing portion.

25. The pill case of claim 24 wherein:
the lid comprises a plurality of snap-in pegs located along the periphery of the lid; and
the housing portion comprises a plurality of recesses located along the periphery of the card receiving area, the plurality of recesses are configured to receive the corresponding pegs for snap-in engagement to secure the lid to the housing portion and maintain the card at a centrally located position within the card receiving area.

26. The promotional item of claim 12 wherein the housing portion comprises a slot for passing the card into the card receiving area.

27. The promotional item of claim 26 wherein the slot is configured to prevent removal of the card from the card receiving area.

28. The promotional item of claim 12 wherein the at least one surface is at least partially transparent.
